(19) United States
(12) Patent Application Publication
(10) Pub. No.: US 2018/0260913 A1
(43) Pub. Date: Sep. 13, 2018

(54) APPARATUS, METHODS, AND ARTICLES OF MANUFACTURE FOR ESTIMATION OF LINK STRENGTHS AND ENTITY INTERCONNECTIONS IN SOCIAL/REFERRAL NETWORKS

(71) Applicant: AcureRate Technologies, Ltd., Raanana (IL)

(72) Inventors: Dror Garti, Modi'in (IL); Doron Herzlich, Raanana (IL)

(21) Appl. No.: 15/918,990

(22) Filed: Mar. 12, 2018

Related U.S. Application Data
(60) Provisional application No. 62/470,373, filed on Mar. 13, 2017.

(51) Int. Cl. G06Q 50/00; G06F 17/30

(52) U.S. Cl. CPC G06Q 50/01; G06F 17/30864

(57) ABSTRACT

To help professionals (source users) reach other professionals (target users), a computer-based system may use as input user contacts and publicly available information to deduce relationships and output ranked paths that originate from the source users, go through third persons that are trusted-referrals or parts of trusted-referral circles, and end at the target users. Trusted referrals can make introductions with an increased probability that both sides will be willing to work with each other. The trust attribute is based on the nature of the relationship between two people and is also measured by strength, based on additional relationship parameters. Exemplary system uses include: a business person locates trusted referrals who can make an introduction to executives of a company, for the purpose of offering consulting services; and people who launched a project locate trusted referrals that can introduce them to angel investors/firms, to obtain project finding.

### CROSS-REFERENCE TO RELATED APPLICATION

This application claims priority from United States provisional patent application serial number 62/470,373, entitled Software System for Discovering Trusted Referrals to Reach Business People, filed on Mar. 13, 2017, which provisional application is hereby incorporated by reference in its entirety as if fully set forth herein, including text, figures, claims, tables, and computer program listing appendices (if present), and all other matter therein.

### FIELD

The present description relates generally to estimation of strengths of links between entities, such as people and companies, and to identification of trusted referral entities. In selected embodiments, the present description relates to estimation of entity-to-entity links in social networks, and creation of relevant interconnections between two entities using a trusted referral entity and/or a trusted referral circuit,

### BACKGROUND

Referrals are often key to developing new business and to identifying product and/or service providers for fulfilling both personal and business needs. The value of a referral depends to a great extent to the referring entity. When the referring entity is trusted by the entity to which the referral is provided or by the entity being referred, the value of the referral may increase greatly. When the referring entity is trusted by both the entity being referred and the entity to which the referral is made, the value of the referral be still greater.

Therefore, it is desirable to provide improved techniques for identifying trusted referral entities, for automating such techniques, and for evaluating potential effectiveness of referrals made with such and other techniques.

### SUMMARY

A need in the art thus exists for improved techniques for identifying trusted referral entities. A need in the art also exists for automating trusted referral techniques. A need in the art additionally exists for evaluating potential effectiveness of referrals.

Embodiments of the present invention are directed to methods, apparatus, and articles of manufacture that satisfy one or more of these needs. Selected embodiments disclosed herein include methods performed by one or more computers.

In an embodiment, a business professional user employs a computer system to reach other business professionals. The system obtains a number of inputs, such as the available contacts of the user and publicly available information to deduce relationships; the system outputs possible ranked paths that originate with the user, go through a third person who is a trusted referral or part of a trusted referral circle, and terminate at the user's targeted business organization or professionals at the targeted business organization. The trusted referral can make the introduction with a good probability that both sides will be willing to work with each other. The trust attribute is based on the nature of the relationship between two people. The strength of the trust attribute may be estimated based on various relationship parameters. In a specific example, the user employs the system to locate one or more trusted referrals who can introduce him or her to one or more senior executives at a certain company, for the purpose of offering his or her consulting services to the company. In another specific example, users who launched a new project employ the system to locate trusted referrals that can introduce the users to angel investors or investment firms that may be interested in funding the project. In still another embodiment a user employs the system to identify a cluster of people who are in tight relations with each other, thus inferring that advertisements served to one person of the cluster may be served to the others in the cluster with a higher likelihood of influencing their conduct than serving the advertisements to random people.

In an example, a computer-implemented method includes receiving at a computer system comprising one or more computers entity information regarding a plurality of entities, the plurality of entities comprising a plurality of natural person entities and a plurality of non-natural person entities, the entity information regarding each natural person entity of the plurality of natural person entities comprising identifier information of said each natural person entity, contact information of said each natural person entity, and relationship information describing one or more relationships of said each natural person entity with one or more other entities of the plurality of entities, the entity information regarding each non-natural person entity of the plurality of non-natural person entities comprising identifier information of said each non-natural person entity, and relationship information describing one or more relationships of said each non-natural person entity with one or more other entities of the plurality of entities. The method also includes storing in a data store of the computer system the entity information, the data store comprising one or more databases. The method additionally includes identifying one or more trust circles with at least three entities in the plurality of natural person entities. The method further includes receiving entity information regarding additional natural person entities, the entity information regarding each additional natural person entity comprising identifier information of said each additional natural person entity, contact information of said each additional natural person entity, and relationship information describing one or more relationships of said each additional natural person entity with one or more other entities of the plurality of entities and the additional person entities, the step of receiving the entity information regarding the additional natural person entities being performed by the computer system. The method further includes supplementing the entity information stored in the data store with the entity information regarding the additional natural person entities, resulting in supplemented entity information stored in the data store. The method further includes adding said each additional natural person entity to the one or more trust circles, if said each additional natural person entity can be added to the one or more trust circles. The method further includes receiving a request for referring a source entity to a target entity, the request being from the source entity, the source entity and the target entity being selected from the group consisting of one of the additional natural person entities and the plurality of entities. The method further includes identifying a first referral path for referring the source entity to the target entity, the first referral path being based on relationship scores and passing through a first single referral unit selected from the group consisting of (1) the plurality of entities and the additional natural person entities, and (2) the one or more trust circles.

In an example, an article of manufacture has one or more non-volatile machine-readable storage media storing program code. The program code includes instructions for performing the steps of the method described in the preceding paragraph.

In an example, a computer system includes one or more computers configured to perform steps of the method described in the preceding paragraphs of this SUMMARY section.

These and other features and aspects of the present invention will be better understood with reference to the following description, drawings, and appended claims.

### BRIEF DESCRIPTION OF THE FIGS.

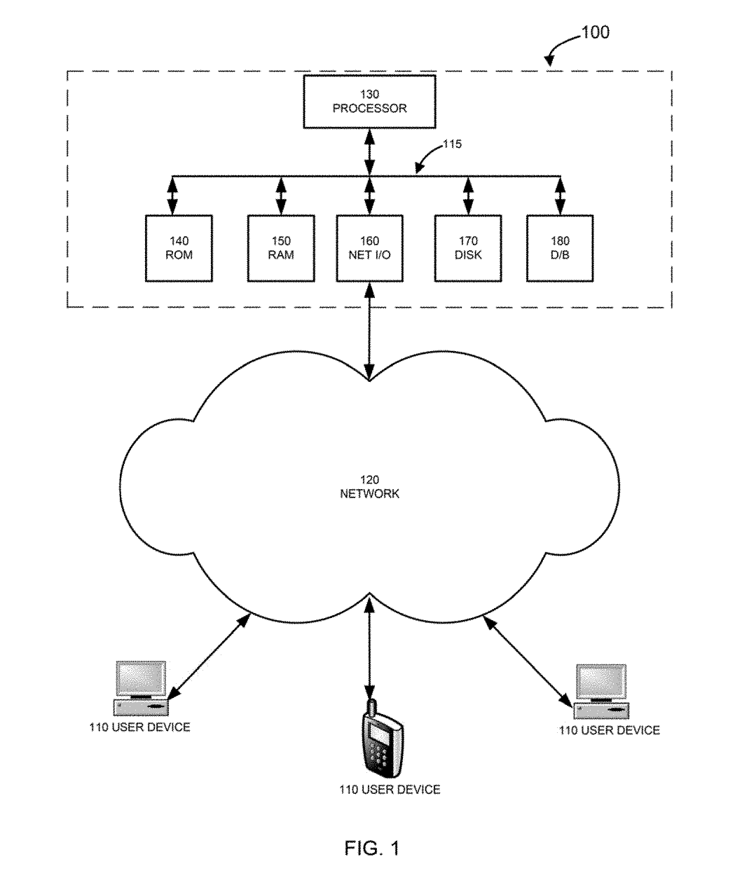

FIG. 1 illustrates selected hardware components of a referral system configured in accordance with selected features described in this document;

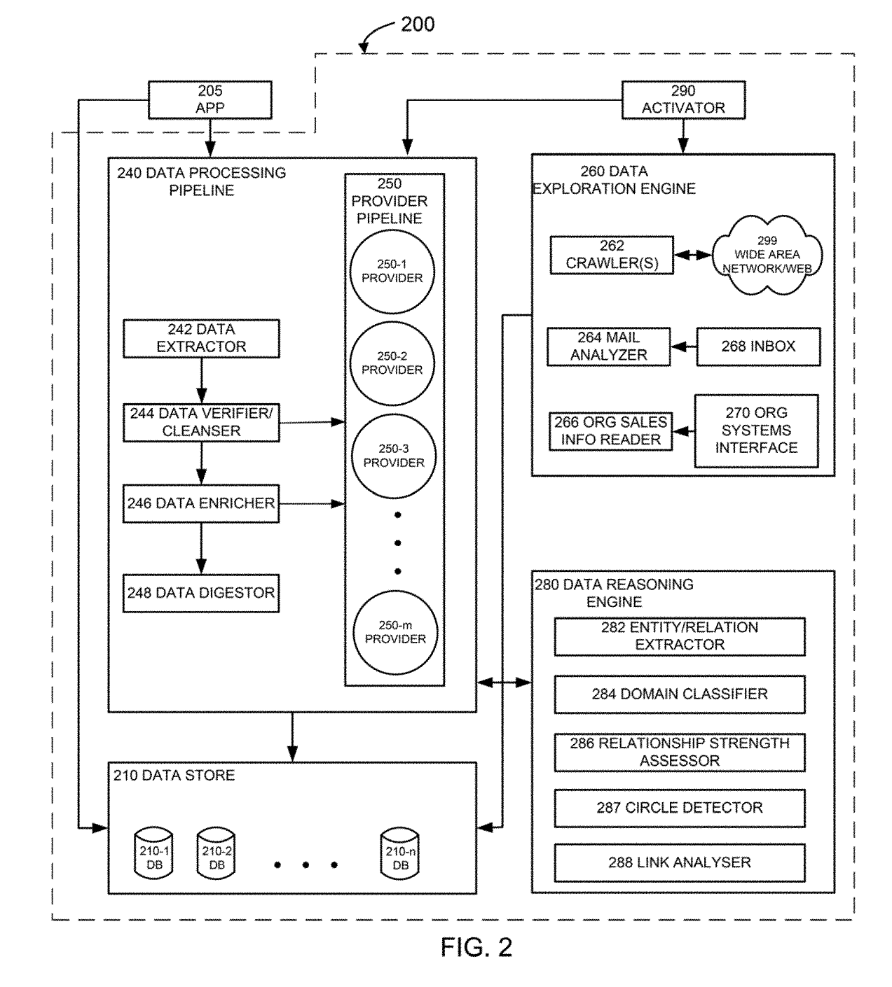

FIG. 2 illustrates selected hardware/software blocks of a referral system that may be built on the hardware platform of the system of FIG. 1, configured in accordance with selected features described in this document;

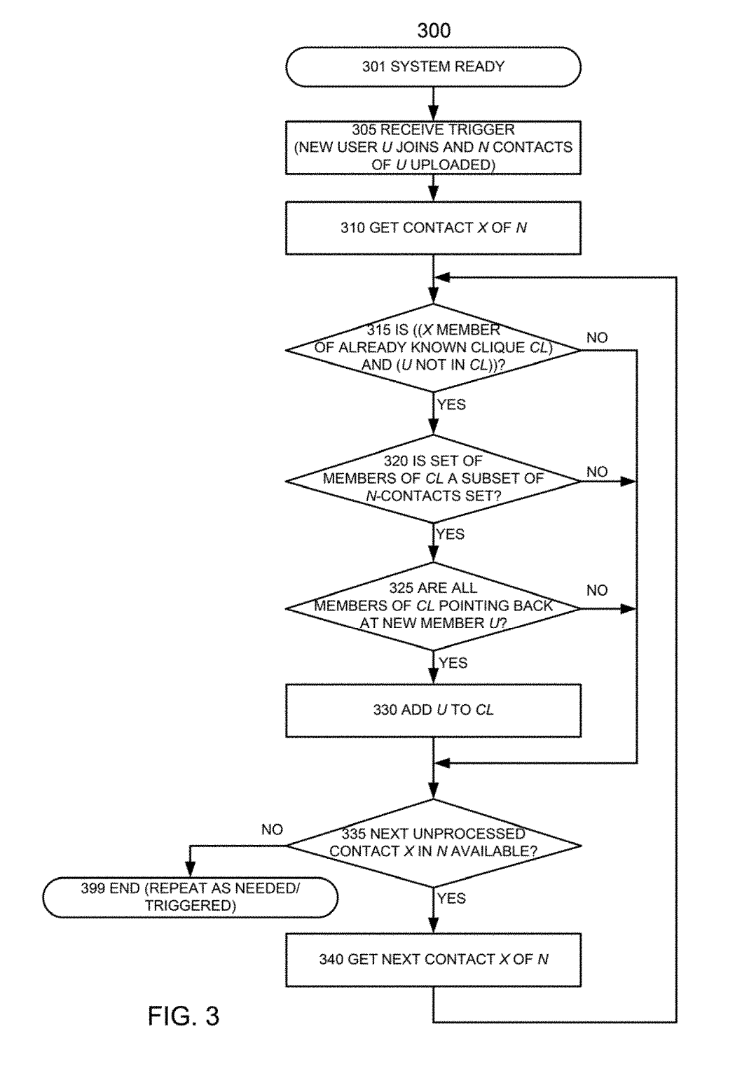

FIG. 3 illustrates selected steps of a method for adding a new user to a referral system, in accordance with selected features described in this document;

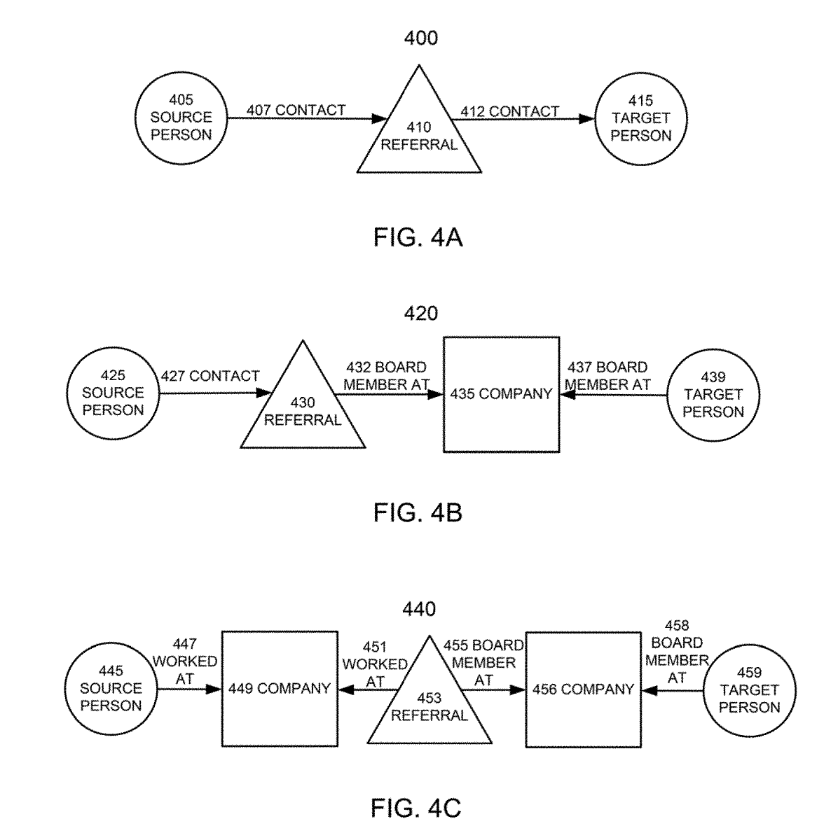

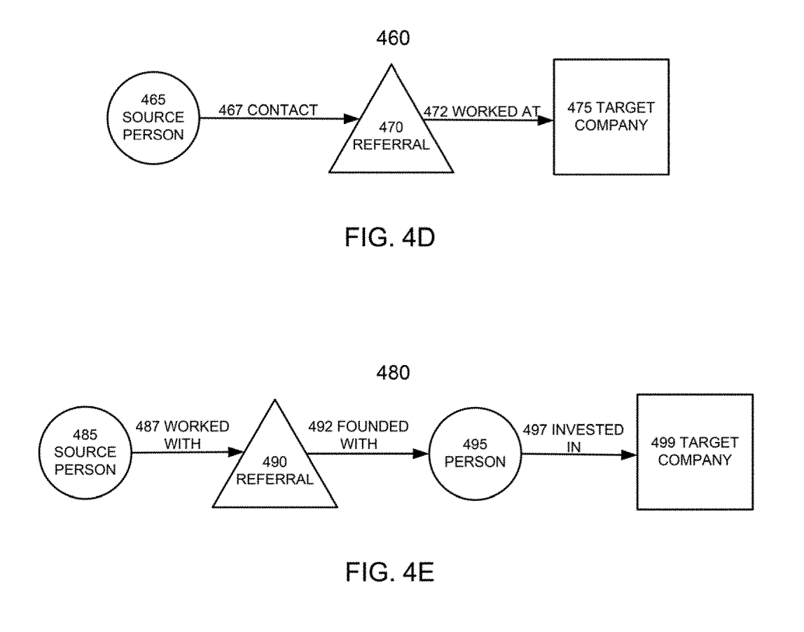

FIGS. 4A, 4B, 4C, 4D, and 4E illustrate exemplary referral paths determined by a to referral system, in accordance with selected features described in this document; and

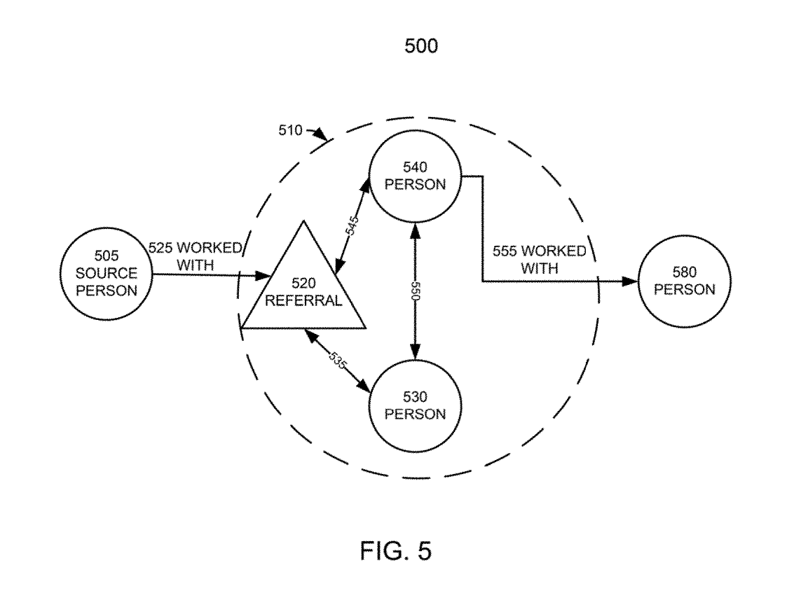

FIG. 5 illustrates exemplary referral path that includes a trusted circle, determined by a referral system, in accordance with selected features described in this document.

### DETAILED DESCRIPTION

In this document, the words “embodiment,” “variant,” “example,” “implementation,” and similar expressions refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” means that the item is used as an example. Such characterization of an embodiment does not necessarily mean that the embodiment is a preferred embodiment; the embodiment may but need not be a currently preferred embodiment. The embodiments are described for illustration purposes and are not necessarily strictly limiting.

The words “couple,” “connect,” and similar expressions with their inflectional morphemes do not necessarily import an immediate or direct connection, but include connections through mediate elements within their meaning, unless otherwise specified or inherently required. Immediate/direct connections also fall within the meaning of the terms.

An “entity” may be a person, a business entity, or another organization. An entity being subject of a referral (for example, a provider of one or more products and/or services) is a “source referral,” a k a “referral source” or simply a “source”; an entity to which the referral is made, for example, a consumer of the one or more products and/or services, is a “referral target” or simply a “target.” A “provider” or “supplier” entity is an entity that provides the product/service that is the subject of a particular referral. A “consumer” or “customer” entity is an entity that receives or consumes the product/service that is the subject of the referral. Note that a source entity may he either a provider/supplier or consumer/customer entity with respect to the same subject of the referral; similarly, a target entity may be either a provider/supplier or consumer/customer entity with respect to the same subject of the referral. For example, a referral may be made of a professional services entity (such as an accounting firm) to another firm that may be in need of the professional services; and vice versa, a referral may be made of the firm in need of the professional services to the professional services entity.

A “dataset” is a collection of data about a particular entity.

Other and further definitions and clarifications of definitions may be found throughout this document.

Reference will now be made in detail to several implementations and to the drawings accompanying this document, which drawings are a part of the description. Same reference numerals are used in the drawings and in this document to refer to the same apparatus elements and method steps. The drawings are in simplified form, not to scale, and omit apparatus elements and method steps that can be added to the described apparatus and methods; while certain optional elements and steps may be included in the drawings.

FIG. 1 illustrates selected components of a system 100 configured in accordance with selected features of this document. The system 100 is coupled to user devices 110 through a communication network 120. FIG. 1 does not show various hardware/software components is and various physical and logical interconnections of some variants. The system 100 can be implemented as a special purpose data processor, a general-purpose computer, a computer system, a group of networked computers or computer systems (each with its own processors/memories and other supporting elements) configured to perform the steps of methods described in this document, alone or in conjunction with other elements such as the user devices 110. In some embodiments, the system 100 is or includes a server. In some embodiments, the system 100 is built on a personal computer platform, such as one or more Wintel PCs or Mac computers. The personal computer may be a desktop computer or a portable computer. (Note that typically, the system 100 will have a number of hardware machines, and exist in a cloud, although these are not requirements.) Each of the user devices 110 may be a desktop computer, a portable computer, a smartphone, a tablet, a wearable computing/communications device (such as glasses or a watch), or another type of computing/communications device. The system 100 may interconnect and function in conjunction with various types of the user devices 100; that is, some user devices 110 may be desktop computers, some bay be portable computers, some may be smartphones, some may be tablets, some may be wearable devices, and some may be devices of still other types.

As is illustrated in FIG. 1, the system 100 includes a processor 130, read only memory (ROM) module 140, random access memory (RAM) module 150, a network interface 160, a mass storage device 170, and a database 180. These components are coupled together by a bus 115. In the illustrated embodiment, the processor 130 is a microprocessor, and the mass storage device 170 is a mass a magnetic disk. The mass storage device 170 and the memory modules 140/150 are connected to the processor 130 so that the processor 130 can write data into and read data from these storage and memory devices. The network interface 160 couples the processor 130 to the communications network 120, which network may include the Internet. The nature of the network 120 and of the devices that may be interposed between the system 100 and the network 120 determine the network interface 160 in the system 100. For example, the network interface 160 may be an Ethernet interface that connects the system 100 to a local area network and through it to the Internet.

The database 180 may be used to organize and store the data that may be needed or desired in performing the methods described in this document. The database 180 may be a physically separate system coupled to the processor 120, or the processor 130 and the mass storage device 170 may be configured to function as the database 180.

The processor 130 is configured to read and execute program code instructions stored in the ROM module 140. Under control of the program code, the processor 130 configures the system 100 to perform all or some of the method steps described in this document. The program code instructions may also be embodied in machine-readable storage media, such as hard drives, floppy diskettes, CD-ROMs, DVDs, flash memories, and similar devices that can store the instructions permanently or temporarily, in a non-transitory manner. The program code can also be transmitted over a transmission medium, for example, over electrical wiring or cabling, through optical fiber, wirelessly, or by any other form of physical transmission. The transmission can take place over a dedicated link between telecommunication devices, or through wide- and local-area networks, such as the Internet, an intranet, extranet, or any other kind of public or private network. In one embodiment, the program code is downloaded to the system 100 through the network interface 160.

The system 100 may implement a server (or servers) of a social network.

Let us now turn to the description of selected tasks performed by the system 100, either alone or in conjunction with the user devices 110. (Note that the program code of the user devices 110 may be stored and/or transmitted in the same manner as has been described above in connection with the program code of the processor 130.) To facilitate this description, FIG. 2 illustrates selected hardware/software blocks of a system 200 that may be built on the hardware platform of the system 100 of FIG. 1. The system 200 may serve as a black-box system for any external application 205 (any usage, any format, mobile or web-based), for example, an application that can inject contacts information and consume the service of locating trusted referrals. The system 200 includes a data store 210, a data processing pipeline 240 (which includes a provider pipeline 250 with providers 250-m), a data exploration engine 260, a data reasoning engine 280, and an activator 290.

The data store 210 combines databases 210-n, storing the information used in operation (assets, data, relations) and providing the functionality and flexibility to run versatile queries on the data to produce paths from sources to targets via trusted referrals. The data store 210 may store entity information, including information describing various entity properties and information describing relationships between and among various entities. The entity properties information regarding people (natural person entities) may include name information, such as first name, last name, middle name, suffix, title, nickname(s); date of birth; location(s) information (such as one or more actual addresses or portions of the address(es)); gender; one or more email addresses; telephone number(s); information regarding one or more jobs, such as job titles, employers, compensation, currency (currently in the position or not), employment separation dates or durations; investment-related information, such as investor in, founder of, board member of. The entity properties information regarding other entities (non-natural person entities, such as companies, firms, schools, academic institutions) may include name information, such as name of the entity, previous name(s) of the entity and any predecessor entities, alias(es); founding year of the entity and founding years of any predecessor entities; public or private company status; number of employees; domain name and related URLs; logos/marks; management information, such as organizational-charts, names of board members and former board members, names of founders, names of investors in the entity.

Information describing relationships between people (natural persons) entities may include worked-with (either yes/no or length of the working together period), works-with (yes/no or length of the currently working together period), reports or reported to (either yes/no or length of the reporting to period), manages/managed (either yes/no or length of the managing period), personal assistant to (either yes/no or length in the personal assistant position); social-network-connected (e.g., yes/no flag that is set in response to any social network connection, a flag for each of several social networks; team-with (e.g., yes/no flag showing current team association; family-with (e.g., yes/no flag indicating a family relationship within a predetermined degree of relatedness or a number reflective of the relatedness), etc. Relationships between people (natural persons) and companies (non-natural person entities) may include employee-of, founder-of, investor-at, board member of, supplier of, consultant to, etc. Relationships between non-natural person entities (e.g., companies) may include acquired-by, acquirer-of, competitor-of, partner-of, etc. The properties and relationships information of entities can be extended, as they portray real-life relationships.

In examples, the data store 210 includes one or more of the following three component types, which are described in no particular order:

1. Big Data NO-SQL database (e.g., MongoDB)—for storing all raw data gathered from contacts, external resources, etc. Every piece of raw data may become useful or required in the future, particularly if new heuristics come become available and the system is programmed to inspect the raw data and re-deduce insights.

2. Big Data Graph database (e.g., Neo4J)—for storing some or all relationships between and among the various system entities, allowing flexibility in querying the relationships to get output paths.

3. Assets database (e.g., Amazon S3)—for storing media-related assets (e.g., videos, photos, etc) Which were harvested during the enrichment process (described below, e.g., in relation to a data enricher 246) and may be needed/desired later when information of an entity is required/desired.

The data store 210 may provide get/set methods operative on person/company entities. For the get methods, it may provide ways to get properties or relationships of an entity or get methods to provide paths. For the set methods, it may provide ways of pushing person/company entities to it, while it maintains transparently the meta-data, the assets, and the relationships.

The data processing pipeline 240 may be triggered/activated by the external application 205. (The triggering/activation may also be internal, as is described in more detail below, particularly in connection with the “Chain-Reaction” concept.) In response, the data processing pipeline 240 obtains one or more records of contacts information (received, e.g., from known sources such as G-mail, Yahoo, Microsoft Outlook, mobile phones apps, a specific request of a user to check on a specific email of phone, a request that may come through the platform's API, etc.). The application 205 may have a single set or multiple sets of records on entities (people/companies) and provide the set(s) to the data processing pipeline 240. The data processing pipeline 240 may employ a data extractor 242, a data verifier/cleanser 244, the data enricher 246, and a data digestor 248 to perform a sequence of respective steps (data extraction, verifying/cleansing, enrichment, digesting), resulting in a verified, rich, comprehensive set of one or more records and the records' inter-relationships, which are put into the data store 210. The data processing pipeline 240 may process a single contact (which preferably includes at least a key contact property such as an email address or telephone number) or a file of contacts which originated from an export actions on any known contact management source or a customer relationship management (“CRM”) system. Contact management sources can be mobile operating system (“OS”) contacts apps; email clients such as Gmail, Yahoo, Microsoft Exchange, iCloud etc.; social networks such as Pacebook, LinkedIn; and any generic comma-separated file. Company information can be any file, e.g., with columnar or other structured data including various company properties.

Through the data extractor 242 of the processing pipeline 240, the system 200 can accept a single record of data or a complete/partial file containing all/some contacts of a specific person or company. The data extractor 242 may map all columns of the source data and read the needed information, taking into account all or some fields of interest (e.g., person name, person email, person telephones, person date of birth, company name, company founding year, company web-site, etc., as has already been mentioned).

People's contacts may often include old or mistyped information, for example, empty or badly formatted name fields, badly formatted emails, and invalid telephone numbers. The data verifier/cleanser 244 performs data verification and cleansing to correct bad information, if possible, by going over the data extracted from the different fields and verifying its correctness. For example, the data verifier,/cleanser 244 may test email addresses and telephone numbers, to determine whether they are still active or have been deactivated or otherwise have become outdated. Records with bad formats or wrong data (“faulty records”) may be discarded, or corrected. Correction may be performed, for example, by comparing the information in the faulty records to related records already stored in the data store 210. For example, if a record includes information such as title or company, the system data verifier/cleanser 244 may inspect it and attempt to verify it against the formal titles and known companies it is familiar with (already in the data store 210). Correction may also be performed by comparing the record to publicly available information, and to other information accessible by the system 200.

The data enricher 246 enriches (adds to) the records of the system 200 using information obtained from the external providers 250-m. The data enricher 246 takes a given record and pushes it to the provider pipeline 250, which is a fully extensible pipeline that may include one or more providers. Each of the providers 250-m is responsible for turning to one or more external public sources that can enrich the person/company data record and provide data on various properties (e.g., titles, jobs, education, location, photos, related links, social profiles, etc.) and relationships (e.g., part of a board of directors, part of a founding team, part of a family, etc.). A particular service can be, for example, an online service approached via API calls, a public news site available on the world-wide-web that can be scraped and the information in it used to enrich the record, or a public profile on a social network page. More providers can be coded and registered with the system to extend further the provider pipeline 250 and enhance it with rich data sources. Each provider 250 may inspect the existing collected properties of a record and decide to use it as key for its following searches. For example, one provider 250 may use email(s) property as its search key, another provider 250 may look for a link (URL) to a specific social network to look at a public profile. The providers 250 may attempt to provide as much entity information and relationship information as possible, even if the information includes properties which are not currently supported by the system 200. Those properties and relationships can be consulted with or inspected later on by the data digestor 248.

The data digestor 248 may perform four related functions, described below in no particular order.

First, the data digestor 248 may process and verify all the information collected from all sources (e.g., if multiple new emails were detected, gather them and leave the unique ones, and rank them according to importance private emails being more important than business ones).

Second, the data digestor 248 may cross-reference all the information together to deduce the final properties values and/or discard contradicting properties. For example, if some sources indicate a particular person is Male, while some other sources indicate the person is Female, this property may be effectively discarded by setting it to remain in “unknown status.” Another example (in the case of a company entity), if there are contradicting founding years for the company, the system may select the earliest date from the founding year date of the set it has.

Third, the data digestor 248 may deduce more information, which may be added to the properties set. For example, if a person has an email someone@company.com and the domain “company.com” is familiar to the system (already extracted by previous operation of the Data Extractor 242 and stored in the data store 210 in relation to some record(s)), the data digestor 248 may deduce that the person works or had worked at the company. This concept—using sub-data pieces to deduce further insights—may be referred to as “Nano-Data Analysis.” Some Nano-Data Analysis can indicate a person's age or a person's location, etc. The data digestor 248 may also deduce a person's level of activity on a social network using other attributes, such as the date the person joined the social network, the person's number of friends/followers, etc.

Fourth, the data digestor 248 may enqueue further enrichment requests to the system (particularly to the data enricher 246) if new information is revealed that would benefit from elaboration. This might be the case, for example, if the data digestor 248 detects a mention of a new company that is not in the data store 210. As another example, assume that the data enricher 246 turned to some “Source A” and received a new email of a person that was unknown to the system; the data digestor 248 may detect that it is new to the system and then re-initiate the pipeline to check and enrich via this new data-piece. This kind of action (performing additional enrichment in response to some new item of information) may be referred to as “Chain-Reaction.”

The data processing pipeline 240 may also be activated by the activator 290 to go over one or more contacts and refresh the information. The activator 290 may activate the data processing pipeline 240 periodically, at predetermined times, in response to occurrence or non-occurrence of one or more conditions/events (including events external to the system 200 and the application 205), at random times, or otherwise. Such triggering/activation is useful because some entity properties may change or be added (after the entity is already in the data store 210); for example, jobs, email addresses, telephone numbers, etc., may be changed or added.

The activator 290 is also configured to trigger the data exploration engine 260, at the same or different times as the data processing pipeline 240. The data exploration engine 260 is configured to explore external sources of data, for example, on the world-wide-web and inside organizations (on private networks), for the purpose of further enriching the records stored in the data store 210.

The data exploration engine 260 may include one or more web crawlers 262 that scan predefined web-sites with predefined search clauses (expressions) to gather relevant information which may assist in enriching the records of the system 200. For example, the crawlers may examine high-tech news web sites and search for articles related to funding, extracting names of companies, team members, investors, and their interrelationships.

The exploration engine 260 may also include mail analyzers 264 operating on mailboxes 268 in the system 200, including mailboxes 268 configured specifically to receive newsletter emails and/or any forwarded emails. The mail analyzers 264 may inspect the lists of email recipients as well as the email content, to gather additional information on people and define relationships between and among them.

The exploration engine 260 may further include an Org Sales Info Reader 266 that integrates with one or more CRM systems and/or external stores where a business may hold its own list of customers/prospects. The exploration engine 260 may employ an interface 270 to such CRM system(s) and/or external stores to import information from these sources for enrichment of the records and relationship information in the data store 210.

The data reasoning engine 280 is configured to provide multiple analysis methods for further extracting and deducing information from the raw data collected by the system 200. Such methods may include Natural Language Processing, Heuristics, Fuzzy Logic methods, and Link-Analysis computational algorithms. The functions of the data reasoning engine 280 are performed by an entity/relation extractor 282, a domain classifier 284, a relationship strength assessor 286, a circle detector 287, and a link analyzer 288. We proceed to describe these modules in more detail, in no particular sequence.

Entity/relations extractor 282 is configured to obtain free texts (e.g., titles of people, partial/full description paragraphs, and even longer texts) and analyze them using NLP (natural s language processing) techniques to extract a list of entities and the relationships between/among them. The texts may be in English or another language; if different language texts are available, the texts may be translated as needed. In embodiments, only English texts are processed; in embodiments, only single language texts are processed; the language may be English. In other embodiments, multiple language texts are processed using machine translations; for example, all texts in a non-primary language are machine-translated into the primary language, which may be English. The unit utilizes a pre-trained Classifier, created by Supervised Machine Learning process that is based on the existing data in the data store 210. Machine Learning may be further enhanced by the system 200 recording user choices when a user selects a specific path from among several paths offered to the user. To elaborate, when the user searches in the system (using the application 205, for example) for a referral, the user is presented with a set of resulting paths that may be ranked and displayed by the system. The user then chooses specific path (or paths) according to the user's Human Intelligence and previous experiences in life. The system 200 marks the user's decision and decisions of other users and adds them to an internal scoring. This may later be taken into account better to decide on the path rankings. The more users use the system 200, the more paths are selected and reviewed, the better are the chances that the system 200 gets “smarter” as the machine actually learns.

The system 200 trains itself and becomes stronger as more information is enriched and analyzed.

The domain classifier 284 is configured to classify (or attempt to classify) entities to predefined categories using various properties gathered on the entity. For people, for example, such classifications may include the following: “Part of the Hi-Tech Industry,” “Angel Investor,” “Lawyer,” “Certified Lawyer” (multiple classification, per state and area of practice), “Government,” etc. For companies, the classifications may include “IPO-ed,” “Acquired,” etc. (Each of the listed classifications has a meaning that is well understood, and that is the meaning intended here.) The domain classifier 284 may use either or both (1) external providers available, for example, on the Internet, and (2) heuristics, to perform the classifications. For example, in many countries an email domain ending with “*.gov.*” can indicate a person belonging to a government institute. Another example is classifying a person as belonging to the academia based on the system 200 learning of the various academic institutions in the world and their attributes (email domains, phone numbers, etc.).

The relationship strength assessor 286 is configured to analyze the relationships between any two entities and calculates a score (or scores, as will become apparent from the following details) for the relationship, to reflect the strength of the relationship. In embodiments, two scores may be calculated; for example, one score reflecting an estimate of the strength of the relationship from a first entity to a second entity (strength of the relationship from the point of view of the first entity), a second score reflecting an estimate of the strength of the relationship from the second entity to the first entity (strength of the relationship from the point of view of the second entity). The strength assessment may be performed, for example, between a person and the person's direct contacts (as imported into the system 200) and between two people whose information was not directly imported into the system, but was deduced and/or obtained from other sources.

We now give more specific examples of relationship strength assessment performed by the relationship strength assessor 286. When assessing strength of a relationship between two people (say A and B) whose contacts are in the data store 210, their attributes in the data store 210 may be given the weights shown in table 1 below.

TABLE 1
exemplary weights of attributes available for an entity

| Attribute | Weight (wᵢ) |
|---|---|
| Business email of one of A/B in | 1 email address - 1 point |
| the other's contacts | 2 email addresses - points |
| | more than 2 addresses - 3 points |
| Private email of one of A/B in the | 1 active email address - 1 point |
| other's contacts | 1 active and >1 non-active email address - points |
| | >2 email addresses (active or not) - 3 points |
| | (an email address is considered “active” if the |
| | email address has an email server which is |
| | attending it, as opposed to “Address Unknown” or |
| | “Message not Delivered” statuses that email |
| | servers may return upon sending a test message to |
| | such an address) |
| Business telephone (landline, | 1 business telephone number - 1 point |
| mobile) number of one of A/B | 2 business telephone numbers - 2 points |
| in the other's contacts | 3 or more business telephone numbers - 3 points |
| | (a business telephone number may be |
| | distinguished from a private telephone number |
| | based, for example, on the type of public listing of |
| | the telephone number (private versus |
| | business/commercial), based on the rubric under |
| | which the telephone number stored in the contacts |
| | (for example, business versus home in Microsoft |
| | Outlook), on association of the telephone number |
| | with a company stored in the data store 210) |
| Private telephone | 1 private telephone number - 1 point |
| (landline/mobile) number of one | 2 private telephone numbers - 2 points |
| of A/B in the other's contacts | 3 or more private telephone numbers - 3 points |
| Date of birth of one of A/B | 3 points |
| available in the other's contacts | |
| LinkedIn Connection | 2 points |
| Twitter connection (follow) | One direction (e.g., A follows B but not vice versa - |
| | 1 point |
| | Bi-directional (A follows B and B follows A - 2 |
| | points |
| Facebook connection | Two persons are connected - 1 point |
| Direct Manager (this | 3 points |
| information may be available in | |
| contacts coming from Microsoft | |
| exchange systems, or from | |
| external data-sources that the | |
| providers of the provider | |
| pipeline 250 may obtain.) | |

If any attribute mentioned in the Table 1 is not available for an entity, zero point weight may be assigned to the weight of the attribute. Note that in variants, not all of the listed attributes are used, and/or additional attributes are used. Also note that the specific numbers of points/weights assigned need not be used in all variants, although they are used in some variants.

In variants, the formula given below is used to combine the assigned weights and provide a score estimating the strength of the relationship: f(x)=Σₙ₌₁^{n=#of attr}wₙ. In words, the value of the score function equals to the sum of the values (point weights) of all the attributes.

In another example, the system assesses strength of a relationship between two people (C and D) whose contacts are not in the data store 210, but were deduced from publicly available sources. In this example, one or more “Trust Circles” (as explained below) of which the two persons are part are considered. “Trust Circles” may be working places, board of advisors teams, founders of a company, colleague executives, college alumni, and other groups of people with strong associations. Each Trust Circle is weighted with a predetermined weight coefficient Cₙ, based on the nature of the particular Trust Circle. For example, a Trust Circle of company thunders may be weighted higher than a Trust Circle of board members of the same company, which in turn may be weighted higher than a Trust Circle of managers of the company, and which may be weighted higher than a Trust Circle of employees of the company. Relationships of the people within a particular Trust Circle may also be attributed with properties and weights, as exemplified in Table 2 below.

TABLE 2
exemplary weights given to circle attributes available for an entity

| Attribute | Explanation | Weight (wₙ) |
|---|---|---|
| Recency | How long ago were the | >3 years - 1 point |
| in Circle | two people last part of the | 2-5 years - 2 points |
| (in years) | circle? | 0-2 years - 3 points |
| Period of time | How long were the two | 0-2 Years - 1 point |
| as part of the | people part of the circle? | 0-5 Years - 2 points |
| Circle | | >5 Years - 3 points |
| (in years) | | |
| Size of Circle | How many participants | >10 people - 1 point |
| (number of | were there in the Circle in | 5-10 people - 2 points |
| people) | addition to the two people? | 1-4 people - 3 points |
| | | (The weight of the Size of |
| | | Circle attribute may be |
| | | determined at the most |
| | | recent time both people |
| | | belonged to the Trust |
| | | Circle, at the time the |
| | | weight is used in the score |
| | | function, or at another |
| | | time) |

If any attribute in Table 2 is not available for an entity, zero may be assigned to weight of the attribute.

Two people may be associated with more than one Trust Circle, thus each Trust Circle may be scored separately (for a given relationship) and the total may be summed up to arrive at the value of the relationship. Thus, a score function f(x) for a relationship between two people in multiple (#circles) trust circles may he computed as follows:

$$f ( x ) = {\sum }_{n = 1}^{\# circles} {c}_{n} {\sum }_{i = 1}^{\# attr} {w}_{n [ i ]} .$$

In the above formula, #circles is the number of Trust Circles to which the two people belong; Cₙ is predetermined weight coefficient of the Trust Circle n; and w_{n[i]} is the weight of the iₜₕ attribute of the relationship in the nₜₕ Trust. Circle.

In operation, the system 200 may continually grow as people and companies (“users”) join and contribute personal and business contacts, and perhaps other information. The system 200, and particularly the circles detector 287, may inspect every new user and its contacts, and detect circles of people who may be well connected to each other in real life. This detection may be performed using a method of detecting “cliques” in the relationships graph. In the mathematical area of graph theory, a clique is a subset of vertices of an undirected graph such that its induced subgraph is complete; that is, every two distinct vertices in the clique are adjacent. The system 200 can run at any time a process detecting any two (or possibly more) entities that point to each other and define them as a clique, i.e., a particular trust circle. Then, the system 200 may perform a process such as the process 300 illustrated in FIG. 3. In FIG. 3, the process 300 may be performed by the circle detector 287 in response to a new user joining the system 200 and uploading the new user's contacts, to determine whether the new user is part of one or more existing cliques, and add the new user to such cliques.

At flow point 301, the system 200 is powered up and ready to perform the process 300.

In step 305, a trigger for performing the other steps of the process is received. As is illustrated in FIG. 3, the trigger here is a new user U joining and uploading the user's N contacts into the system. Note that U may already be a contact of one or more other users of the system and therefore known to the system.

In step 310, a current contact X is selected first. In embodiments, it does not matter in which order the contacts of U are processed. So, for example, the contacts may be processed in the alphabetical order (or reverse alphabetical order) of surnames, in order of increasing or decreasing telephone numbers, in order the contacts appear in the file U submitted, or any other order.

In decision block 315, it is determined whether the current contact X is a member of a known clique CL and the new member U is not in the CL. If both conditions are not satisfied (i.e., either X is not a member of a known clique, or U is already in the known clique), process flow jumps to decision block 335. Otherwise, process flow continues to decision block 320.

In the decision block 320, it is determined whether CL (the clique of which X is a member and U is not a member) is a subset of the N contacts of U. If not, process flow jumps to the decision block 335. Otherwise, process flow continues to decision block 325.

In the decision block 325, it is determined whether all members of CL point back at the new user U on the graph of the users of the system. If this condition is not satisfied, process flow jumps to the decision block 335. Otherwise, process flow continues to step 330.

In the step 330, U is added to CL, and process flow continues to the decision block 335.

In the decision block 335, it is determined whether an unprocessed contact in N remains. If all the N contacts added by U have been processed, process flow may continue to flow point 399, where the process ends, but may be repeated as needed.

Otherwise, process flow continues to step 340, where a new contact X is selected and the sequence of 315-335 is repeated for the new X. Thus, all the contacts added by the new member U are processed.

In a variant, the process 300 is modified to account for the possibility that the current X may be a member of multiple cliques of Which U is not a member. In this case, the sequence 320-330 may be repeated for each such clique, so that U may be added to multiple cliques during processing of the same X.

As noted above, the system 200 can run at any time a process detecting any two (or possibly more than two) entities that point to each other and define them as a clique. Thus, the system 200 may identify new cliques after adding one or more users through the process 300 or otherwise. The system 200 may perform the process for identifying cliques in response to any user changing (adding, deleting, modifying) the user's contacts; in response to new information becoming available (such as through the data exploration engine 260, the data processing pipeline 240, and/or the provider pipeline 250); in response to a change in the parameters of or information available to the entity/relation extractor 282 or the domain classifier 284; in response to the activator 290 triggering the data processing pipeline 240 and/or the data exploration engine 260; in response to the external application 205 triggering the data processing pipeline 240; at predetermined and/or random times; in response to one or more predetermined external conditions meeting one or more criteria; and/or otherwise.

Since new contacts uploaded are compared against existing cliques in the process 300, the system 200 continually and actively maintains all the known cliques in the graph and marks them. These cliques may later on be used as part of the path deducing system and also considered based on the relationships strengths. For example, family members may he strong cliques, as each member holds multiple contact information on the other family members, thus making the relationships within the family clique strong. The strength may be reflected in the increased value of the corresponding Cₙ of the trust circle.

The system 200 employs the link analyzer 288 to analyze the entity relationships stored in the data store 210, and to answer various queries related to paths which are based on the relationships and properties in the data store 210. The link analyzer 288 is configured to attempt to determine a path from a specified source to a specified target that passes through only a single person, whose link/path to the target may have a relatively high (above a predetermined threshold) value or the highest value, as scored by the score function. (Such person or persons may be considered trusted referrals.) Examples of possible path templates are illustrated in FIGS. 4A, 4B, 4C, 4D, and 4E, in which circles designate people (natural persons), squares designate companies (non-natural persons), and triangles designate trusted referral persons; the relationships mentioned on the arrows can change and, in fact, can be any of the relationships mentioned as well as other relationships (e.g., Family With, Reports To, etc.).

The system 200 is configured to search for the path that connects one person to another through a single trusted referral person. FIG. 4A illustrates such a path 400 from a source person 405 to a target person 415 via a trusted referral 410. The system 200 is configured to search for a path 407 from the source 405 to the referral 410, and for a path 412 from the referral 410 to the target 415. As illustrated in FIG. 4A, the separate components (407/412) of the path 400 may connect two people (405/415) when their relationships to the trusted referral are inferred from the contacts uploaded to the system 200. As will be seen below, some parts of the end-to-end path may include intermediate company entities in the middle, which may also be inferred from the enrichment process. Furthermore, the different parts of the end-to-end path such as the path 400 may be filtered on any attribute of the relationships, so, for example, the end-to-end path includes connections of certain strength or people of certain seniority (position at a workplace).

The directions of the arrows 407/412 indicate the directions of the relationships. As shown, the trusted referral 410 is a contact of the source person 405, and the target person 415 is a contact of the trusted referral 410. The directions of the arrows 407 and/or 412 may be reversed; for example, reversing the arrow 407 would indicate that the source person 405 is a contact of the trusted referral 410, and reversing the arrow 412 would indicate that the trusted referral 410 is a contact of the target person 415. The arrows may also be double-headed (<−−>), indicating that each of the two persons at the ends of the arrows is a contact of the other person. In searching for a trusted referral, the system 200 may give different weights to the different directions. For example, the path direction indicating that the trusted referral person is a contact of either the source person (or the target person) may be less valuable than the path direction indicating that the source person (or the target person) is a contact of the referral person; or vice versa.

FIG. 4B illustrates a path 420 between a source person 425 and a target person 439. The path 420 includes: a path 427 (the referral person 430 is a contact of a source person 425); a path 432 (the referral person 430 is a board member of a company 435); and a path 437 (the target person 439 is also a board member of the company 435).

FIG. 4C illustrates a path 440 between a source person 445 and a target person 459. The path 440 includes: a path 447 (the source person 445 worked at a company 449); a path 451 (a referral person 453 also worked at the company 449); a path 455 (the referral person 453 is a board member of a company 456); and a path 458 (the target person 459 is also a board member of the company 456). As before, the different directions (including the double-headed arrows) may be assigned different values in the searches for referral paths, and the types of relationship may also be valued differently. For example, “worked at” may be valued differently than “contact of”; “founder of” may be valued differently than “board member at.” The relationships may also be valued based at least in part on other relationships. Furthermore, an arrow may indicate multiple simultaneous relationships; for example, a first person may be a contact of a second person, and at the same time the two persons may have worked or still be working together at the same company. A path with multiple simultaneous relationships may be valued higher than a path with a single relationship; in embodiments only the most important (highest valued) relationship is scored/considered. It should also be noted that some relationships should be valued so as to avoid connections through them, depending on context. For example, a person seeking a referral for a job might not want to be connected to another company through a board member or an employee of the company where the person currently works.

Continuing with path examples, FIG. 4D illustrates a path 460 from a source person 465 to a target company 475 through a trusted referral 470. The path 460 includes a path 467, indicating that the trusted referral 470 is a contact of the source person 465, and a path 472, indicating that the trusted referral 470 worked at the target company 475.

FIG. 4E illustrates a path 480 from a source person 485 to a target company 499. The path 480 includes: a path 487, indicating that a trusted referral 490 is a contact of the source person 485; a path 492, indicating that the trusted referral 490 founded some company (which may but need not be the target company 499) together with another person 495; and a path 497, indicating that the person 495 invested in the target company 499.

In embodiments (including those illustrated in FIG. 4D and FIG. 4E), the system 200 is configured to search for a path from a source person to a specific target company via a trusted referral by searching for a path between the source person and a referral person that either has a direct relationship with the company or can connect to another person related (preferably directly) to the target company.

The system 200 may also search for a path that connects a source person to a specific target entity (person or company) through a trusted referral and another person, where the trusted referral and the other person are both in a trust circle (a clique in a relationship graph). Trusted referral circles are treated as a single entity as people who are part of a circle generally may have very strong connections and act as a group, often willing to use their inner connections (within the same circle) further to refer a person with some connection to the circle. The system 200 may be configured to search for a path between the source person and a referral person that is part of a trust circle where one of the other members can connect to the target person or company. FIG. 5 illustrates an example of a path template with a trust circle. As in the case of other templates (FIGS. 4A, 4B, 4C, 4D, 4E), the relationships mentioned on some of the arrows may change.

In FIG. 5, a path 500 connects a source person 505 to a target person 580 through a trust circle 510. As illustrated, the trust circle 510 includes: a person 520 who is a trusted referral of the source person 505 because 505 and 520 worked together, as is indicated by a path 525; a person 530 within the trust circle 510, connected to the trusted referral 520 by a path 535; and a person 540 also within the trust circle 510, connected to the trusted referral 520 by a path 545, and to the person 530 by a path 550. The person 540 is connected to the target person 580 IS by a path 555, indicating that 540 and 580 worked together.

In operation, multiple users join the system 210 and upload their contacts. The system determines various trust circles. When each additional user joins, the system performs a method such as the method 300, to determine to which cliques to add the new user. Once this is done, a source user may indicate desirability of a referral to a particular target entity. The system 100 then evaluates and scores various possibilities of referral persons that are trusted by the target entity or another person not far removed from the target entity. (For example, directly connected to the target entity.) One type of trusted referral is a referral person whose relationship with the target entity scores (with an appropriate score function as has been described) at or above a predetermined threshold. Another type of trusted referral is a referral person within a trusted circle (clique) in which some member has a relationship with the referral entity that has a score above a certain threshold. One or more paths from the source person to the target entity are then evaluated and one or more most preferable one(s) are presented to the source user. Note than not all the entities in the data store 210 are necessarily users of the system 200 (although in examples, that is the case), and so the path(s) may be plotted and evaluated through non-users, and the target entity itself need not be (but may be) a user of the system 200. In examples, shortest paths (with fewest intermediate paths or “hops”) are preferred to longer paths. Path-to-path comparisons may be performed using path of the same length, for example, comparing a two-hop path through a trusted referral or trusted circle to other two-hop paths that include trusted referrals or trusted circles. A hop within a trusted circle may be counted as a partial hop or not counted at all. In embodiments, only

Although the process steps and decisions may be described serially, certain steps and decisions may be performed by separate elements in conjunction or in parallel, asynchronously or synchronously, in a pipelined manner, or otherwise. There is no particular requirement that the steps and decisions be performed in the same order in which this description lists them, except where a specific order is inherently required, explicitly indicated, or is otherwise made clear from the context. Furthermore, not every illustrated step and decision block may be required in every embodiment in accordance with the invention(s), while some steps and decision blocks that have not been specifically illustrated, may he desirable or necessary in some embodiments in accordance with the invention(s). The specific sequences of the illustrated steps/decisions are exemplary.

This document describes in detail the inventive apparatus, methods, and articles of manufacture (that store machine-executable instructions implementing the methods) for operating trusted referral systems. This was done for illustration purposes. Neither the specific embodiments of the invention(s) as a whole, nor those of its/their features necessarily limit the general principles underlying the invention(s). The specific features described herein may he used in some embodiments, but not in others, without departure from the spirit and scope of the description as set forth herein. Various physical arrangements of components and various step sequences also fall within the intended scope of the invention. Many additional modifications are intended in the foregoing disclosure, and it will be appreciated by those of ordinary skill in the art that in some instances some features of the invention(s) will be employed in the absence of a corresponding use of other features. The illustrative examples therefore do not necessarily define the metes and bounds of the invention(s) and the legal protection afforded the invention(s), which function is carried out by current and future claims and their equivalents.

What is claimed is:

1. A computer-implemented method, comprising:
receiving at a computer system comprising one or more computers entity information regarding a plurality of entities, the plurality of entities comprising a plurality of natural person entities and a plurality of non-natural person entities, the entity information regarding each natural person entity of the plurality of natural person entities comprising identifier information of said each natural person entity, contact information of said each natural person entity, and relationship information describing one or more relationships of said each natural person entity with one or more other entities of the plurality of entities, the entity information regarding each non-natural person entity of the plurality of non-natural person entities comprising identifier information of said each non-natural person entity, and relationship information describing one or more relationships of said each non-natural person entity with one or more other entities of the plurality of entities;
storing in a data store of the computer system the entity information, the data store comprising one or more databases;
identifying one or more trust circles with at least three entities in the plurality of natural person entities;
receiving entity information regarding additional natural person entities, the entity information regarding each additional natural person entity comprising identifier information of said each additional natural person entity, contact information of said each additional natural person entity, and relationship information describing one or more relationships of said each additional natural person entity with one or more other entities of the plurality of entities and the additional person entities, the step of receiving the entity information regarding the additional natural person entities being performed by the computer system;
supplementing the entity information stored in the data store with the entity information regarding the additional natural person entities, resulting in supplemented entity information stored in the data store;
adding said each additional natural person entity to the one or more trust circles, if said each additional natural person entity can be added to the one or more trust circles;
receiving a request for referring a source entity to a target entity, the request being from the source entity, the source entity and the target entity being selected from the group consisting of one of the additional natural person entities and the plurality of entities; and
identifying a first referral path for referring the source entity to the target entity, the first referral path being based on relationship scores and passing through a first single referral unit selected from the group consisting of (1) the plurality of entities and the additional natural person entities, and (2) the one or more trust circles.

2. The method as in claim I, further comprising: providing information regarding the first referral path to the source entity, the step of providing comprising at least one step selected from the group consisting of: displaying the information regarding the first referral path to the source entity, audibly announcing the information regarding the first referral path to the source entity, transmitting electronically the information regarding the first referral to the source entity, storing the information regarding the first referral path in a memory location accessible to the source entity.

3. The method as in claim 2, wherein the first referral unit is a first trust circle that has a direct relationship between a first natural person member of the first trust circle and the target entity and a direct relationship between the source person and a second natural person member of the first trust circle.

4. The method as in claim 3, further comprising step for scoring the direct relationship between the source entity and the second natural person member of the first trust circle, and step for scoring the direct relationship between the target entity and the first natural person member of the first trust circle.

5. The method as in claim 4, wherein the step of adding said each additional natural person entity comprises step for adding said each additional natural person entity to the one or more trust circles.

6. The method of claim 5, wherein the target entity is a natural person target entity.

7. The method of claim 5, wherein the target entity is a non-natural person target entity.

8. The method of claim 5, wherein:
the step of receiving the entity information regarding the additional natural person entities comprises receiving entity information regarding a first additional natural person entity;
the step for adding said each additional natural person entity to the one or more trust circles comprises step for adding the first additional natural person entity to the one or more trust circles;
the step for adding the first additional natural person entity to the one or more trust circles is performed in response to the step of receiving the entity information regarding the first additional natural person entity; and
the first additional natural person entity is selected from the group consisting of first natural person member of the first trust circle and the second natural person member of the first trust circle.

9. The method of claim 5, further comprising performing verification and cleansing on the supplemented entity information stored in the data store, the step of performing being computer-implemented.

10. The method of claim 9, wherein the step of performing verification and cleansing comprises comparing one or more records of the supplemented entity information to publicly available online information.

11. The method of claim 10, further comprising first enriching the supplemented entity information stored in the data store with information from one or more external public sources, the one or more external public sources being selected from the group consisting of online services accessed through APE calls, public news sites available on the WWW that can be scraped, and public profiles available on social network pages, the step of first enriching being computer implemented.

12. The method of claim 11, comprising digesting the supplemented entity information stored in the data store to discard contradicting properties, and performing nano-data analysis to enhance the supplemented entity information by deducing additional insights from sub-data pieces of the supplemented entity information.

13. The method of claim 11, further comprising second enriching the supplemented entity information with data obtained by operating one or more web crawlers to scan predetermined web sites using one or more predetermined search expressions.

14. The method of claim 13, further comprising third enriching the supplemented entity information with data obtained from a mail analyzer operating on one or more mailboxes configured to receive newsletter emails.

15. The method of claim 13, further comprising third enriching the supplemented entity information with data obtained from a mail analyzer operating on one or more mailboxes configured to receive newsletter emails and forwarded emails, wherein the mail analyzer is configured to examine email content and lists of recipients in the emails in the one or more mailboxes.

16. The method of claim 3, further comprising:
identifying a second referral path for referring the source person to the target person, the second referral path being based on relationship scores and passing through a second single referral unit selected from the group consisting of (1) the plurality of entities and the additional natural person entities, and (2) the one or more trust circles, the second referral unit being different from the first referral unit; and
providing information regarding the second referral path to the source entity.

17. The method of claim 16, wherein the second single referral unit is a second trust circle.

18. The method of claim 16, wherein the second single referral unit is a natural person entity.

19. An article of manufacture comprising one or more non-volatile machine-readable storage media with program code stored in the one or more non-volatile machine-readable storage media, the program code comprising instructions for:
receiving at a computer system comprising one or more computers entity information regarding a plurality of entities, the plurality of entities comprising a plurality of natural person entities and a plurality of non-natural person entities, the entity information regarding each natural person entity of the plurality of natural person entities comprising identifier information of said each natural person entity, contact information of said each natural person entity, and relationship information describing one or more relationships of said each natural person entity with one or more other entities of the plurality of entities, the entity information regarding each non-natural person entity of the plurality of non-natural person entities comprising identifier information of said each non-natural person entity, and relationship information describing one or more relationships of said each non-natural person entity with one or more other entities of the plurality of entities;
storing in a data store of the computer system the entity information, the data store comprising one or more databases;
identifying one or more trust circles with at least three entities in the plurality of natural person entities;
receiving entity information regarding additional natural person entities, the entity information regarding each additional natural person entity comprising identifier information of said each additional natural person entity, contact information of said each additional natural person entity, and relationship information describing one or more relationships of said each additional natural person entity with one or more other entities of the plurality of entities and the additional person entities, the step of receiving the entity information regarding the additional natural person entities being performed by the computer system;
supplementing the entity information stored in the data store with the entity information regarding the additional natural person entities, resulting in supplemented entity information stored in the data store;
adding said each additional natural person entity to the one or more trust circles, if said each additional natural person entity can be added to the one or more trust circles;
receiving a request for referring a source entity to a target entity, the request being from the source entity, the source entity and the target entity being selected from the group consisting of one of the additional natural person entities and the plurality of entities; and
identifying a first referral path for referring the source entity to the target entity, the first referral path being based on relationship scores and passing through a first single referral unit selected from the group consisting of (1) the plurality of entities and the additional natural person entities, and (2) the one or more trust circles.

20. A computer system comprising one or more computers configured to perform steps of a method comprising:
receiving at the computer system entity information regarding a plurality of entities, the plurality of entities comprising a plurality of natural person entities and a plurality of non-natural person entities, the entity information regarding each natural person entity of the plurality of natural person entities comprising identifier information of said each natural person entity, contact information of said each natural person entity, and relationship information describing one or more relationships of said each natural person entity with one or more other entities of the plurality of entities, the entity information regarding each non-natural person entity of the plurality of non-natural person entities comprising identifier information of said each non-natural person entity, and relationship information describing one or more relationships of said each non-natural person entity with one or more other entities of the plurality of entities;
storing in a data store of the computer system the entity information, the data store comprising one or more databases;
identifying one or more trust circles with at least three entities in the plurality of natural person entities;
receiving entity information regarding additional natural person entities, the entity information regarding each additional natural person entity comprising identifier information of said each additional natural person entity, contact information of said each additional natural person entity, and relationship information describing one or more relationships of said each additional natural person entity with one or more other entities of the plurality of entities and the additional person entities, the step of receiving the entity information regarding the additional natural person entities being performed by the computer system;
supplementing the entity information stored in the data store with the entity information regarding the additional natural person entities, resulting in supplemented entity information stored in the data store;
adding said each additional natural person entity to the one or more trust circles, if said each additional natural person entity can be added to the one or more trust circles;
receiving a request for referring a source entity to a target entity, the request being from the source entity, the source entity and the target entity being selected from the group consisting of one of the additional natural person entities and the plurality of entities; and
identifying a first referral path for referring the source entity to the target entity, the first referral path being based on relationship scores and passing through a first single referral unit selected from the group consisting of (1) the plurality of entities and the additional natural person entities, and (2) the one or more trust circles.
